(19) United States
(12) Patent Application Publication
(10) Pub. No.: US 2026/0019358 A1
(43) Pub. Date: Jan. 15, 2026

(54) ENDPOINT IDENTITY AND RELATIONSHIP OBFUSCATION

(71) Applicant: DISPERSIVE HOLDINGS, INC., Roswell, GA (US)

(72) Inventor: Scott E. Higgins, Herriman, UT (US)

(21) Appl. No.: 18/772,963

(22) Filed: Jul. 15, 2024

(51) Int. Cl. H04L 45/24; H04L 9/16; H04L 67/14

(52) U.S. Cl. CPC H04L 45/24; H04L 9/16; H04L 67/14

(57) ABSTRACT

The disclosed system discussed herein may include systems and methods for endpoint identity and relationship obscuration. One or more client connection attributes may be received. The one or more client connection attributes may be determined by an abstraction layer of a network based on network traffic associated with the network and one or more common connection attributes stored in a database. One or more network settings may be determined based on the one or more client connection attributes. A plurality of encryption keys may be determined based on the one or more network settings. One or more data packets may be encrypted based on the plurality of encryption keys. The one or more encrypted data packets may be transmitted to a plurality of network nodes based on the one or more network settings.

### TECHNICAL FIELD

The present disclosure generally relates to network security and more particularly to systems and methods for obscuring the identity and relationships of endpoints in a network to prevent unauthorized analysis and tracking of network traffic.

### BACKGROUND

In today's interconnected world, the security of network communications is of paramount importance. Traditional network security measures focus on communication reliability, performance, data integrity, and data security. However, as bad actors become more sophisticated in regard to analyzing network traffic and/or identifying network patterns, these traditional measures are not sufficient for many organizations. An additional layer of security is needed to protect the identities and relationships of nodes within the organizations’ networks. For example, this need arises particularly in scenarios where network traffic analysis could jeopardize operations, such as in covert operations, law enforcement, intelligence communities, military operations, situations involving informants, or in the secure handling of financial transactions and sensitive corporate communications.

In response to these challenges, there is a growing demand for solutions that can obscure the identity and relationships of network nodes, ensuring that network traffic appears generic and typical, making it difficult or impossible to associate two nodes based on their network patterns.

This background information is provided to reveal information believed by the applicant to be of possible relevance. No admission is necessarily intended, nor should be construed, that any of the preceding information constitutes prior art.

### SUMMARY

Briefly described, and in various embodiments, the present disclosure generally relates to systems and methods for obscuring the identity and relationships of endpoints in a network to prevent unauthorized analysis and tracking of network traffic. According to some aspects, the disclosure aims to meet these requirements by leveraging advanced techniques to blend network traffic into the background of common internet traffic, thereby preventing unauthorized analysis and tracking. This comprehensive approach addresses the critical need for enhanced security in sensitive operations where traditional network security measures fall short.

The envisioned system may include a computing device, including a processor, which may receive client connection attributes, which may be determined by an abstraction layer of a network based on network traffic associated with the common connection attributes stored in a database. The database storing the common connection attributes may be part of a virtual private cloud which may provide enhanced security and isolation from public networks. According to an aspect, the client connection attributes may be updated based on a non-linear schedule which may enhance security and unpredictability. Network settings may be determined based on the client connection attributes. Domain names or paths that are common in internet traffic may be selected when determining the network settings, in order to blend the encrypted data packets with typical traffic and avoid detection. The client connection attributes may be updated based on a non-linear schedule which may enhance security and unpredictability. Updated client connection attributes may be periodically received from a generic storage account. The generic storage account may be part of a cloud service that may ensure that the attributes are common and uninteresting to external observers.

According to some aspects, the client connection attributes may be based on the geographical location of the client node. The consideration of the geographical location may help optimize network settings based on local network conditions and threats. The abstraction layer may adjust the client connection attributes in real-time based on analysis of conditions associated with the network traffic. Adjusting the attributes may include dynamically altering the attributes to respond to changing security threats. Communication with the abstraction layer may be facilitated by an API over secure channels, thus ensuring that all exchanges of information remain confidential.

According to a further aspect, the client connection attributes may include network configuration data (e.g., data representing closed network ports). The network configuration data may aid in misleading network scans and analyses. The client connection attributes and network capacity may be dynamically scaled to respond to fluctuations in network demand and threat levels in order to optimize performance and security.

According to a further aspect, the one or more client connection attributes may be determined based on a deflection technique. The deflection technique may mislead eavesdroppers by variably altering communication protocols and routing information. Further, the deflection technique may include dynamically selecting data paths based on real-time assessments of network congestion and perceived security threats in order to optimize the security and efficiency of data transmissions.

The network traffic may be managed by a dedicated session controller. The dedicated session controller may direct the flow of data packets based on current network load and security protocols. The network settings may include dynamically selected network ports or encryption protocols that may increase the difficulty for unauthorized observers to detect or intercept network traffic. Encryption keys may be determined using the network settings in order to encrypt data packets. The encryption keys may be generated by a cryptographic multi-path algorithm that leverages multiple paths through the network, thus obscuring the data routing.

The encrypted data packets may then be transmitted to network nodes (e.g., based on a randomized routing path). For example, the randomized routing path may mislead potential eaves droppers and may prevent tracking of data flows. Moreover, the encryption of the data packets may be associated with multiple encryption layers. The multiple encryption layers may complicate the decryption efforts by any unauthorized entities. According to some aspects, the encrypted data packets may be transmitted through a gateway in a virtual private cloud in order to prevent any association of the data packets with specific client operations or locations.

According to a further aspect, the system may include a session controller that manages the transmissions of the encrypted data packets in a manner that obfuscates associated traffic patterns. The session controller may increase the difficulty for external analysis to link specific operations or data flows to the computing device. A status report may be transmitted to a network management system. The status report may include a current status and effectiveness of the network settings and security measures.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE FIGURES

Reference will now be made to the accompanying drawings, which are not necessarily drawn to scale.

FIG. 1 illustrates an exemplary networked environment according to various embodiments of the present disclosure;

FIG. 2 illustrates an exemplary networked environment according to various embodiments of the present disclosure;

FIG. 3 illustrates an exemplary networked environment according to various embodiments of the present disclosure;

FIG. 4 illustrates an exemplary networked environment according to various embodiments of the present disclosure;

FIG. 5 illustrates an exemplary process for obscuring the identity and relationships of endpoints in a network according to various embodiments of the present disclosure;

FIG. 6 illustrates an exemplary diagrammatic representation of a machine in the form of a computer system according to various embodiments of the present disclosure; and

FIG. 7 illustrates a schematic of an exemplary device according to various embodiments of the present disclosure.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

The present disclosure relates to methods and systems for endpoint identity and relationship obscuration. The disclosed endpoint identity and relationship obscuration may enhance network security by preventing unauthorized analysis and tracking of network traffic. This enhanced network security may be particularly crucial for scenarios such as covert operations, law enforcement, intelligence, military operations, situations involving informants, or in the secure handling of financial transactions and sensitive corporate communications. According to some aspects, the enhanced network security may ensure that network traffic appears generic and typical. For example, the enhanced network security may make it difficult or impossible to associate nodes based on their network patterns or data packet fingerprinting.

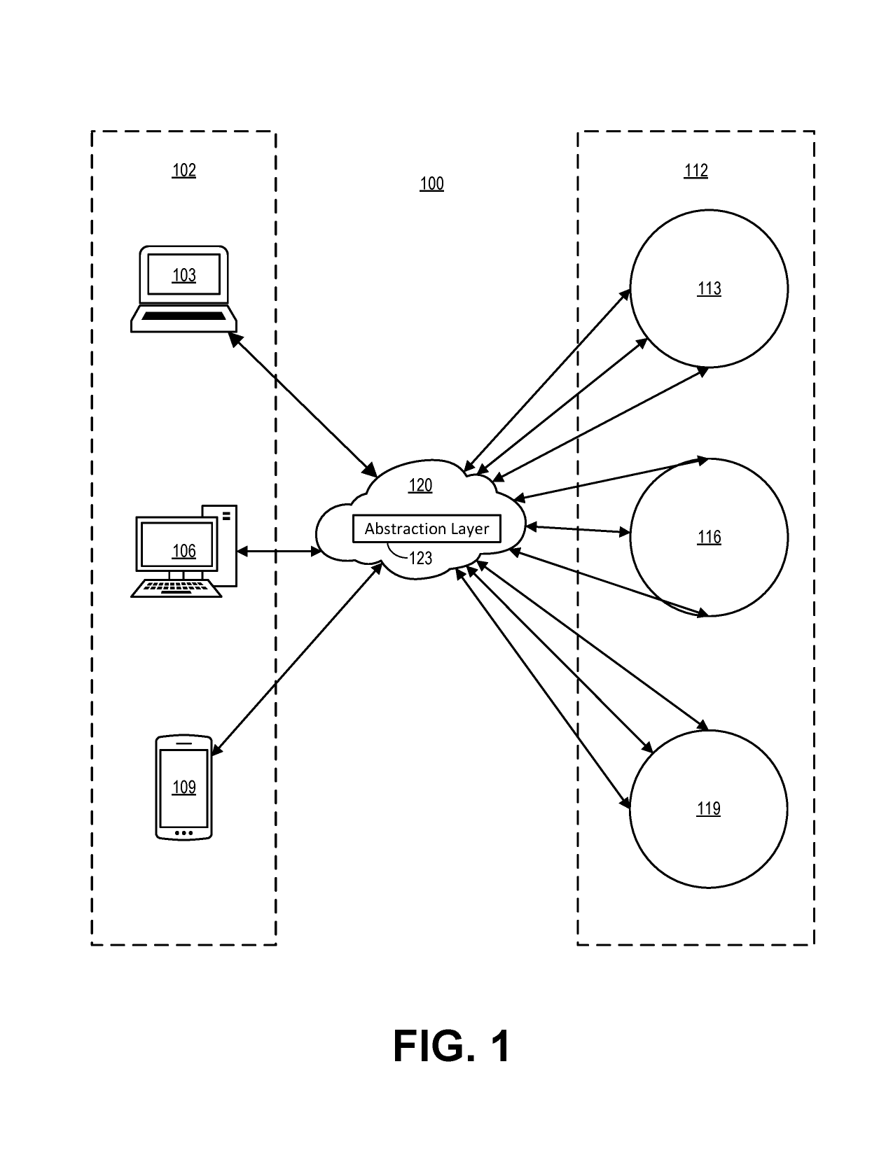

According to some aspects, a multi-layered approach may be leveraged to obscure the identity and relationships of network nodes. As illustrated in FIG. 1, an exemplary environment 100 may include various nodes 112 connected via a network 120. The nodes 112 may be endpoints to each other. An endpoint may be a remote computing device that communicates back and forth with a network (e.g., network 120) to which it is connected. Examples of endpoints may be desktops, laptops, smartphones tablets, servers, workstations, internet-of-things devices or any other client device. Environment 100 may include client devices 102 such as laptop 103, desktop 106, or smartphone 109. The client devices 102 may be communicatively connected to various nodes such as node 113, node 116, or node 119 via network 120.

Moreover, endpoints may include interfaces where communications originate or terminate within the network 120. The endpoints may facilitate entry and exit of data and may include both user-facing devices and internal network components. For example, an endpoint may be a remote computing device that communicates back and forth with network 120. Examples of endpoints may include desktops, laptops, mobile devices (e.g., smartphones), tablets, servers, workstations, internet-of-things devices or any other client device. According to some aspects, endpoints may include nodes 112 when the nodes 112 interact directly with other network segments or external networks, such as edge routers or gateway devices.

Nodes 112 may serve as relay points, routing, or processing data as it travels across the network 120. Nodes 112 may be responsible for maintaining the flow and integrity of communications within the environment 100. Examples of nodes 112 may include routers, switches, and bridges, which may direct traffic based on network protocols and addresses. Infrastructure components, such as certain nodes 112 may also function as endpoints when they serve as communication interfaces, such as VoIP phones or network-enabled printers. According to some aspects, client devices 102 (e.g., laptops or smartphone, although not traditionally considered network nodes due to their typical roles as endpoints, may be capable of routing functions (e.g., tethering or peer-to-peer networking).

Client devices 102 may include types of network endpoints specifically used by end-users or client applications to access services and perform tasks over network 120. The client devices 102 may initiate requests to servers and consume the resources provided by network services. Examples of client devices 102 may include laptops, smartphones, and tablets used to access web services, corporate data, or personal communications. In contrast to nodes 112, client devices 102 may be primarily concerned with the consumption rather than the distribution of network resources. However, in certain peer-to-peer network models, client devices 102 may perform as nodes 112, directly engaging in the routing and processing of data, though they may continue to function as endpoints.

The network 120 of environment 100 may address multiple layers of security considerations to enhance operational security. For example, network packets and traffic may be disguised to blend seamlessly with common network traffic, ensuring that they do not stand out or draw attention. The network 120 may implement techniques to ensure that related nodes are not identifiable through network traffic analysis, thereby protecting the relationships between nodes 112 from being exposed. Additionally, the network 120 may prevent multiple nodes, such as remote clients, from connecting to a common endpoint, reducing the risk of centralized points of failure or attack. To achieve these security objectives, network 120 may leverage a combination of cloud technologies, abstraction layers, and dynamic attribute management. The components of environment 100 may work together to obfuscate traffic patterns, dynamically adjust network settings, and/or manage connection attributes in a way that enhances security and operational integrity.

Network 120 may leverage a variety of strategies in order to blend network traffic and maintain secrecy of operational relationships. The network 120 may use single or multi-cloud topologies to blend network traffic into large volumes of generic traffic. is the blending may be achieved by ensuring that network attributes are similar and uninteresting, making them indistinguishable from regular network traffic. A common cloud storage feature such as those in AWS or Azure may be used to stage connection details. Network 120 may utilize node anonymity, where no node in the network traffic path can be identifiable as a special-use asset. The node anonymity may aid in preventing cybercriminals or bad actors from recognizing specific nodes as targets. Network 120 may also deny node association in order to prevent identification of multiple client nodes, such as laptop 103, desktop 106, and smartphone 109, as connecting to the same destination.

Network 120 may include an abstraction layer 123. The abstraction layer 123 may determine connection attributes for each node 112 and/or client device 102, e.g., during initial setup and/or at periodic intervals. The abstraction layer 123 may ensure that connection attributes are hidden within network 120 to prevent patterns from being detected. Connection attributes may include characteristics of the connection. Example of connection attributes may include network ports, protocols, encryption certificates, domain names, network paths, destination IP addresses, timing attributes, data packet size, session duration, session frequency, device identification, and/or geolocation data. By employing a combination of these attributes and dynamically adjusting them, environment 100 may ensure that network traffic remains indistinguishable from common internet traffic and may make it exceedingly difficult for attackers or observers to identify nodes 112 or establish relationships based on network traffic analysis.

Network 120 may implement a dispersive virtual private cloud (VPC). For example, network 120 may create a lightweight and elastic Dispersive VPC stamp that maintains a one-to-one cloud-to-client relationship. The Dispersive VPC may prevent associations between client connections based on network or traffic attributes. The VPC may include a controller, session controllers, deflects, a gateway, API, and/or an orchestrator. A Dispersive Micro Cloud may communicate with the backend using a separate, non-public IP to maintain operational secrecy. Network 120 may utilize automation to scale out or in based on capacity requirements, optimizing network resources and management. Connectivity patterns may be optimized based on client geolocation to enhance performance and security. Network 120 may leverage a variety of cryptographic, multi-path, and path optimization features to secure all client-to-Dispersive Micro Cloud network connectivity. Cryptographic features may include generating multiple encryption keys and using layered encryption to protect data packets, ensuring robust security.

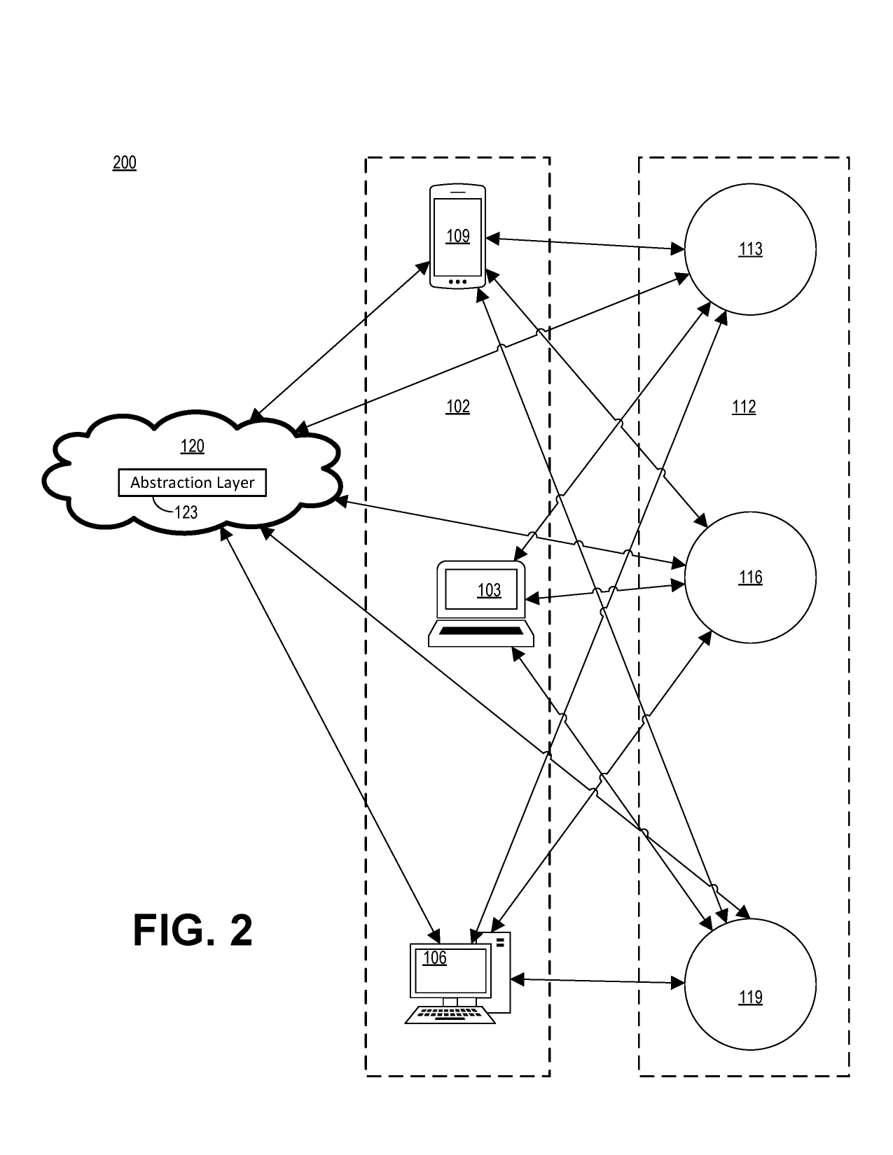

As shown in FIG. 2, the networked environment 200 may obfuscate network traffic among a variety of nodes and endpoints. Environment 200 may include client devices 102, such as laptop 103, desktop 106, and smartphone 109. The client devices 102 may be communicatively connected to various nodes 112, such as node 113, node 116, or node 119 via network 120.

Network 120 in environment 200 may incorporate multiple layers of security to ensure that network packets and traffic blend seamlessly with common network traffic. The network 120 may prevent identification of related nodes through traffic analysis. The network 120 may avoid having multiple remote clients (e.g., laptop 103, desktop 106, and/or smartphone 109) connect to a common endpoint (e.g., node 113, node 116, or node 119). Environment 200 may accomplish obfuscation objectives using a combination of cloud technologies, abstraction layers, and/or dynamic attribute management.

Network 120 may employ various strategies to enhance security by blending network traffic. The various strategies may include using single or multi-cloud topologies to merge network traffic with large volumes of generic traffic, making the network traffic indistinguishable from regular network traffic. One or more cloud storage solutions, such as Amazon Web Services (AWS) or Azure, may be used to store connection details. Additionally, node anonymity may be maintained to ensure no node can be identified as a special-use asset, preventing cybercriminals from targeting specific nodes. To further protect operational secrecy, the network 120 may prevent multiple client nodes from being identified as connecting to the same destination.

The network 120 may incorporate an abstraction layer 123. The abstraction layer 123 may determine connection attributes for each client node (e.g., laptop 103, desktop 106, and smartphone 109) during initial setup and at periodic intervals. The abstraction layer 123 within network 120 may conceal connection attributes and disrupt predictable network patterns by employing a series of advanced algorithms and protocols. For example, the abstraction layer 123 may continuously shuffle and reassign network attributes, such as IP addresses, port numbers, and protocol settings. The dynamic reassignment may be based on real-time network traffic analysis to mask the true nature of the traffic flow and the identities of the communicating endpoints. For example, a node that served as an entry point for sensitive data may randomly switch roles and appear as a benign endpoint, thereby confusing potential eavesdroppers.

Moreover, the abstraction layer 123 may utilize machine learning techniques to predict and mitigate potential threats before they manifest. By analyzing historical and real-time data, the abstraction layer 123 may identify patterns that might indicate a breach or an attempt at unauthorized tracking. Once a potential threat is identified, the abstraction layer 123 may alter the communication patterns of the network 120. Changing the communication patterns of the network 120 may include changing data routes, modifying the timing of transmissions, and/or deploying decoy traffic. By proactively changing the communication patterns of the network 120, the abstraction layer 123 may prevent compromise of data and ensure that operation of the network 120 remains seamless and undisturbed. For instance, in a scenario where a suspicious increase in request rates from a particular node is detected, the abstraction layer 123 may redirect its traffic through more secure, scrutinized paths or temporarily isolate it to prevent potential data leakage.

According to some aspects, the abstraction layer 123 may interface with other network security components to provide a cohesive defense mechanism. For example, the abstraction layer 123 may synchronize with firewalls, intrusion detection systems (IDS), and/or secure gateways to enforce security policies and respond to anomalies. By integrating its functions with these systems, the abstraction layer 123 may ensure that any adjustments to connection attributes or network paths are compliant with overall security protocols. This integration may facilitate a layered security approach, where different components may work in concert to obscure the internal operations of the network 120 from the outside world. For example, while the abstraction layer 123 adjusts the routing and attributes of the network traffic, the firewalls and IDS may focus on analyzing incoming and outgoing packets for threats, e.g., creating a robust, multi-faceted security environment.

Moreover, the abstraction layer 123 may incorporate encryption techniques that use dynamically generated keys to enhance the effectiveness of the obfuscation tactics. The dynamically generated keys may be frequently updated and distributed across the network 120 in a manner that aligns with the current security posture as determined by the abstraction layer 123. Frequently updating the dynamically generated keys may ensure that even if some data packets are intercepted during transmission, deciphering the data packets may become exceedingly difficult without the updated keys. For example, encryption keys may be rotated for each session to prevent interception and fraud.

The abstraction layer 123 may also manage the distribution and lifecycle of these keys, ensuring they are securely stored and accessible only to authorized network components. Managing the distribution and lifecycle of the keys may be achieved through secure key management protocols that may govern the generation and distribution of keys, as well as monitor their usage and retirement. According to some aspects, secure key management protocols may maintain the integrity of the encryption process and by extension, the security of the network 120.

Moreover, the abstraction layer 123 may control the geographical distribution of data traffic by modifying and managing operational parameters of the network 120. By strategically routing traffic through various data centers across different regions, the abstraction layer 123 may further enhance the obscurity of the data flow, making it difficult for attackers to pinpoint the origin or destination of the transmissions. This geographical spreading of data may complicate external attempts to track or analyze the traffic and/or optimize performance of the network 120 by balancing the load across multiple servers.

One or more connection attributes may be dynamically managed to maintain the stealth and integrity of network operations within environment 200. Connection attributes such as network ports, protocols, encryption certificates, domain names, network paths, destination IP addresses, and even finer details like timing attributes, data packet sizes, session durations, session frequencies, device identification, and geolocation data may be systematically varied. This variation may camouflage network activity within the volume of typical internet traffic, thereby complicating the task for potential intruders attempting to discern distinctive patterns or draw connections between nodes based on traffic analysis.

Network 120 may implement a specially configured dispersive virtual private cloud (VPC). The Dispersive VPC may be both lightweight and elastic, adapting seamlessly to the fluctuating demands of network traffic while maintaining strict one-to-one cloud-to-client relationships. This architecture may effectively prevent the correlation of client connections based on shared network or traffic attributes. The infrastructure of the VPC may encompass various critical components including one or more of a dedicated controller, multiple session controllers, and sophisticated traffic deflectors, all coordinated through a central API and an orchestrator. Communication between the Dispersive VPC and the backend may be conducted over isolated, non-public IP addresses to safeguard against external breaches. Furthermore, the VPC may leverage automated scalability to adjust its resources dynamically in response to varying load requirements and may optimize connectivity by considering the geolocation of clients. Network 120 may integrate advanced cryptographic techniques, utilizing multi-path routing and path optimization strategies to secure the communication between clients and the Dispersive Micro Cloud. For example, network 120 may generate multiple encryption keys and the apply layered encryption strategies across data transmissions, thereby ensuring a high level of data protection.

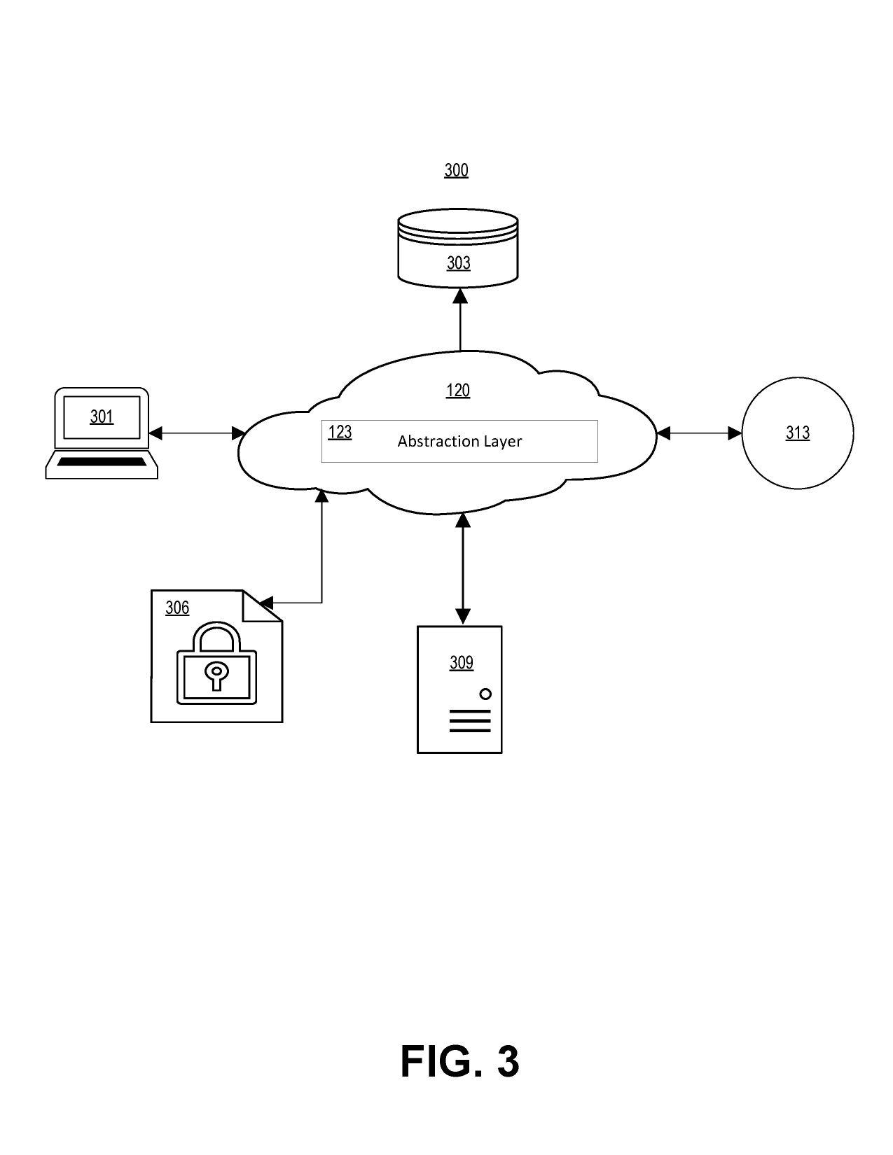

As shown in FIG. 3, an exemplary environment 300 may obscure the identity and relationships of endpoints in a network 120. The environment 300 may include a client 301, a database 303, an encryption service 306, a server 309, and a node 313. Each of the elements of environment 300 may be endpoints connected via network 120. An endpoint may be a remote computing device that communicates back and forth with a network to which it is connected, such as network 120. Network 120 may include abstraction layer 123. Node 313 may be an endpoint to which the client 301 is connected.

According to some aspects, the server 309 may act as a central processing unit within the environment 300. Server 309 may manage and orchestrate the various components of environment 300 to ensure secure and efficient network communication. For example, the server 309 may initiate and control communication sessions between client 301 and the network 120. Moreover, server 309 may ensure that each session is securely established and maintained. The server 309 may receive and process connection attributes from various client nodes, such as client 301, connected to network 120. The server 309 may act as a processing unit for the abstraction layer 123 in network 120, determining and managing the connection attributes.

The network 120 may be configured to receive the connection attributes of client 301 from server 309. Connection attributes may include characteristics of the connection, such as login timeout, number of seconds to wait while trying to connect before timing out, and/or transaction isolation level. According to some aspects, connection attributes may include one or more of network ports, protocols, encryption certificates, domain names, network paths, destination IP addresses, timing attributes, data packet size, session duration, session frequency, device identification, or geolocation data.

The connection attributes may be determined by the abstraction layer 123 of network 120 based on the network traffic associated with the environment 300 and common connection attributes stored in database 303. Abstraction layer 123 may enhance security and maintain operational secrecy by obfuscating connection attributes. The primary purpose of abstraction layer 123 may be to dynamically determine and manage the connection attributes for each client node, such as client 301, during both initial setup and at periodic intervals. By doing so, the abstraction layer 123 may ensure that connection attributes are concealed within the network 120, preventing the detection of patterns that could be exploited by attackers. This dynamic and concealed management of connection attributes may make network traffic indistinguishable from common internet traffic, thereby thwarting attempts by unauthorized observers to identify nodes or establish relationships through network traffic analysis.

According to some aspects, database 303 may include a cloud storage feature, such as those in AWS or Azure, to store connection details. By using a cloud storage feature, database 303 may provide a secure, scalable, and easily accessible repository for storing and managing connection attributes. The connection details may include network ports, protocols, encryption certificates, domain names, network paths, destination IP addresses, and other relevant data required for establishing secure and anonymous network connections. The cloud storage of database 303 may ensure availability and reliability. Connection attributes may be accessed whenever needed without downtime. The cloud storage may include security features, including access control, monitoring, and protecting connection details from unauthorized access and tampering. The cloud storage of database 303 may also store encryption keys utilized by encryption service 306. For example, the cloud storage of database 303 may scale to accommodate growing amounts of connection data, supporting an increasing number of client nodes and dynamic connection attributes. Storing connection details in the cloud may allow for easy updates and retrieval, enabling the environment 300 to dynamically adjust connection attributes at initial setup and periodic intervals. By using a common and uninteresting source such as a generic storage account in the cloud, the environment 300 may ensure that the retrieval and distribution of connection details do not raise suspicion or reveal patterns that could be exploited by attackers.

Network settings may be determined based on the client connection attributes. Encryption service 306 may determine encryption keys based on the network settings and may encrypt data packets based on the encryption keys. Encryption service 306 may use a variety of encryption keys. For example, encryption keys may include symmetric encryption keys, asymmetric encryption keys, hybrid encryption keys, session keys, derived keys, multi-path keys, and/or layered encryption keys. Moreover, encryption service 306 may utilize a Public Key Infrastructure (PKI) to manage the encryption keys. For example, a cloud-based PKI may operate as a backend remote service that centralizes management of the one or more encryption keys, where the encryption keys may be generated, distributed, and stored securely. The cloud-based PKI may automate the renewal and revocation of certificates to further enhance the trustworthiness of the encryption process. By employing a combination of these encryption keys, the encryption service 306 may ensure that data packets are securely encrypted, providing robust protection against unauthorized access and eavesdropping. The encrypted data packets may then be transmitted to node 313.

According to some aspects, the client connection attributes may be updated based on a non-linear schedule. Updating the client connection attributes using a non-linear schedule may increase the unpredictability of the connection and enhance the security of the network 120. Moreover, pattern detection may be avoided, and complexity may be added, making it harder for attackers to predict changes and identify nodes. Updating connection attributes on a non-linear schedule may thwart eavesdroppers who rely on consistent network behaviors and mitigate attack vectors by minimizing predictable windows of opportunity. Non-linear updates may allow dynamic responses to real-time threats, adapting security measures based on the current landscape and ensuring flexibility. This security strategy may maintain operational secrecy, crucial for law enforcement, intelligence operations, and military communications, by preventing adversaries from detecting node presence or relationships. The security strategy may reduce single points of failure and improve network robustness, making the disclosed system a moving target that is difficult to exploit. Moreover, non-linear updates may significantly enhance network security and resilience, protecting sensitive operations and information.

According to some aspects, client connection attributes may include network configuration data (e.g., data representing closed network ports), which may be used to mislead network scans and analyses by unauthorized entities. According to some aspects, a closed network port may refer to a network port that is not actively listening for incoming connections. For example, ports may include virtual endpoints used for communication between different applications or services. When a port is closed, no application or service actively monitors the closed port for incoming data packets, preventing unauthorized access or communication with a particular service or application. Moreover, a closed port may not respond to connection attempts, helping to protect against certain types of cyberattacks, such as port scanning.

According to some aspects, the one or more network settings may include a plurality of dynamically selected network ports or encryption protocols. By dynamically selecting network ports or encryption protocols, the disclosed system may make it more difficult for potential attackers to identify and intercept communications. For example, changing network ports or encryption protocols regularly may help prevent attackers from mapping out the network and identifying potential vulnerabilities. Additionally, using a variety of ports or protocols may improve the overall reliability of the disclosed system, adapting to changing network conditions and security requirements. Accordingly, a layer of complexity and unpredictability may be added to network communications, making it harder for attackers to compromise the network.

In some embodiments, the encryption keys may be generated by encryption service 306. The encryption keys may be generated using a cryptographic multi-path algorithm that leverages multiple paths through network 120. By using multiple paths, the encryption service 306 may distribute the encryption workload and data packets across different routes, reducing the risk of interception or tampering by malicious entities. The overall efficiency of the encryption process may be improved by allowing for parallel processing of data packets on different paths. Additionally, using multiple paths may enhance the fault tolerance of network 120, as it can continue to function even if one or more paths are compromised or experience issues. Accordingly, the security, reliability, and efficiency of data transmission in the network 120 may be improved.

In some embodiments, the encryption of the data packets may be associated with a plurality of encryption layers and algorithms. Each encryption layer may add an additional level of complexity and security, making it more difficult for unauthorized entities to decrypt the data. The layered encryption or nested encryption may provide a form of defense in depth, where even if one encryption layer is compromised, the data may remain protected by the remaining layers. Additionally, using multiple encryption layers may also help mitigate risk of attacks that target specific encryption algorithms or keys, as different layers may use different algorithms or keys, further enhancing the overall security of the data transmission.

In some embodiments, the one or more encrypted data packets may be transmitted to the plurality of network nodes based on a randomized routing path. Randomized routing paths may make it challenging for potential attackers to predict the path of the data packets, thereby reducing the risk of interception or eavesdropping. The resilience of the network 120 may be improved by adapting to changing network conditions and potential threats. By using randomized routing paths, the data packets may be delivered securely and efficiently, even in the presence of malicious entities attempting to intercept or disrupt the transmission.

According to some aspects, determining the one or more client connection attributes may include consideration of the geographical location of the client node. Determining the one or more client connection attributes by considering the geographical location of the client node may optimize network settings based on local network conditions and threats. By considering the geographical location of the client node, connection attributes (e.g., network ports, protocols, and encryption certificates) may be adjusted to ensure optimal performance and security. For example, network paths that minimize latency and congestion for clients in a specific region may be selected. Additionally, considering the geographical location may aid in tailoring security measures to address region-specific threats, enhancing the overall security posture of the network.

According to some aspects, the abstraction layer 123 may adjust the client connection attributes in real-time based on analysis of conditions associated with the network traffic. By continuously analyzing network traffic conditions, the abstraction layer 123 may dynamically adjust connection attributes such as network ports, protocols, and encryption certificates to respond to changing security threats and network conditions. Performance of the network 120 may be optimized by ensuring that the connection attributes are always aligned with the current network environment. Additionally, by adapting to evolving threats, the abstraction layer may proactively mitigate potential security risks, improving the overall security posture of the network.

In some embodiments, determining the one or more network settings may include selecting domain names or paths that are common in internet traffic to blend the encrypted data packets with typical network traffic, e.g., making them less conspicuous and reducing the likelihood of detection. By using common domain names or paths, encrypted data packets may appear similar to regular internet traffic, making it harder for potential eavesdroppers or attackers to distinguish them from legitimate traffic. The anonymity and security of the network 120 may be maintained by reducing the risk of detection and interception of the encrypted data packets.

According to some aspects, the network traffic may be managed by a dedicated session controller to ensure efficient and secure routing of data packets within the network 120. The session controller may serve as a centralized control point that directs the flow of data packets based on current network conditions, security protocols, and load balancing requirements. By centralizing the management of network traffic, the session controller may optimize the routing paths, prioritize traffic, and ensure that data packets are delivered securely and efficiently. The overall performance of the network 120 may be improved by reducing latency and enhancing the security of data transmissions.

According to some aspects, the server 309 may transmit a status report to a network management system to provide real-time monitoring and management of the network 120. By sending regular status reports, the server may allow the network management system to keep track of the health and performance of the network 120, including the status of client connections, encryption processes, and overall network traffic. This information may enable the network management system to detect and respond to any potential issues or security threats promptly, ensuring the network 120 operates smoothly and securely. Additionally, the status reports may be used to optimize network resources, identify areas for improvement, and maintain a high level of network performance.

According to some aspects, communication between the server 309 and the abstraction layer 123 may be facilitated by an application programming interface (API) over secure channels to ensure the integrity and confidentiality of the data exchanged between the two components. For example, using an API over secure channels (e.g., HTTPS) may protect the communication from eavesdropping, tampering, and unauthorized access. Moreover, using an API over secure channels may ensure that the server and the abstraction layer can exchange information, such as client connection attributes and network settings, in a secure and reliable manner. Additionally, using an API may simplify the integration and communication between the server 309 and the abstraction layer 123 and enable seamless operation and efficient management of the network 120.

According to some aspects, client connection attributes and network capacity may be dynamically scaled to respond to fluctuations in network demand and threat levels (e.g., optimizing performance and security). By monitoring network conditions and threat intelligence, the environment 300 may adjust client connection attributes, such as network ports and encryption protocols, to ensure efficient and secure data transmission. Additionally, the environment 300 may scale network capacity up or down to accommodate fluctuations in network traffic and mitigate potential threats. This dynamic scaling may maintain optimal network performance, minimizing latency, and enhance the overall security posture of the network 120.

According to some aspects, encrypted data packets may be transmitted through a gateway in a VPC. For example, by routing the encrypted data packets through a gateway within the VPC, the environment 300 may ensure that the data remains isolated from the public internet and is only accessible within the secure VPC environment. Transmitting encrypted data packets through a secure gateway may add an additional layer of protection against unauthorized access and eavesdropping, e.g., making them difficult to intercept or tamper with. Additionally, data may be transmitted securely between the client 301 and the server 309 by using a gateway within the VPC and the integrity of the network 120 may be maintained.

According to some aspects, a session controller may manage the transmissions of the one or more encrypted data packets in a manner that obfuscates associated traffic patterns. By dynamically adjusting the routing of encrypted data packets, the session controller may obfuscate traffic patterns, making it difficult for potential eavesdroppers or attackers to discern meaningful information from the network traffic. The anonymity of network nodes and relationships may be maintained, and the confidentiality of the data being transmitted may be protected. Additionally, by obfuscating traffic patterns, the session controller may mitigate the risk of traffic analysis and enhance the overall security posture of the network 120.

According to some aspects, determining the one or more client connection attributes may be based on a deflection technique to mislead potential eavesdroppers and attackers by variably altering communication protocols and routing information. The deflection technique may include dynamically selecting data paths based on real-time assessments of network congestion and perceived security threats. By continuously monitoring network conditions, such as congestion levels and security threats, the deflection technique may intelligently route data packets along paths that are less congested and more secure, ensuring that data is transmitted quickly and securely and minimizing the risk of delays or interception. The deflection technique may include introduction of randomness or unpredictability into network communications, such as by using different paths, ports, or protocols for each connection. Moreover, the deflection technique may conceal the true nature of the network traffic and make it more difficult for attackers to detect patterns or associate specific nodes with their activities, enhancing the security and privacy of the network 120 and protecting against traffic analysis and unauthorized access. Additionally, by dynamically selecting data paths, the deflection technique can adapt to changing network conditions and threats, providing a flexible and responsive network infrastructure.

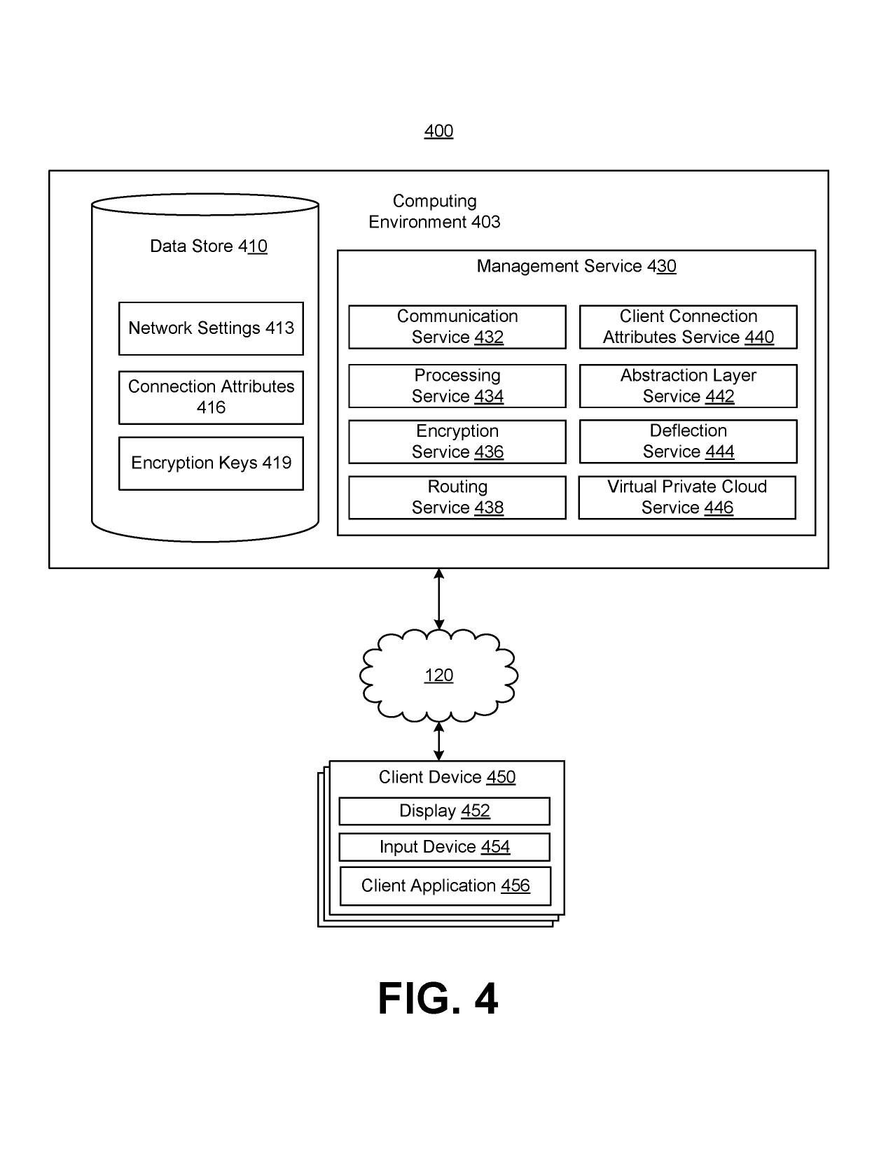

As shown in FIG. 4, the networked environment 400 may obfuscate network traffic among a variety of nodes and endpoints, providing client device 450 with a secure and anonymous connection in network 120. The networked environment 400 may include a computing environment 403, external resources 406, and client device 450, one or more of which may be interlinked via a network 120. One or more of the client devices 450 may comprise a display 452, input device 454, and/or a client application 456. Network 120, including one or more of the Internet, LANs, WANs, and wireless connections, may provide communication within the networked environment 400, including real-time data exchanges, updates, and interactions.

The computing environment 403 may operate within a single device or may span across multiple devices or servers. These devices, potentially distributed across different locations, may work collectively to process, administer, and manage the network traffic associated with the network 120. Moreover, the computing environment 403 may adapt to the computational demands, making it an elastic resource capable of scaling according to the operational needs of the network 120. The computing environment 403 may handle crucial tasks such as managing and the various components to ensure secure and efficient network communication positioning it as the central node of the networked environment.

The datastore 410 may serve as a repository for an array of data types associated with the network 120 operation, including network settings 413, connection attributes 416, encryption keys 419, and various other datasets that may contribute to the network traffic of network 120.

The network settings 413 may include a variety of parameters that govern the behavior and configuration of network 120. Examples of network settings may include, but are not limited to, network ports, encryption protocols, routing tables, Quality of Service (QoS) settings, firewall rules, and DNS configurations. Network ports may indicate communication endpoints for network services. Encryption protocols may define how data is encrypted and decrypted during transmission. Routing tables may specify the paths that data packets take through the network. QoS settings may include prioritization of certain types of traffic for better performance. Firewall rules may control access to and from the network, and DNS configurations may map domain names to IP addresses. The network settings may collectively define the structure and operation of the network 120, allowing the network 120 to function securely and efficiently.

The connection attributes 416 may be based on the network settings 413 and may include various parameters that define the characteristics and behavior of a network connection. Examples of connection attributes may include network ports, protocols, encryption certificates, domain names, network paths, destination IP addresses, timing attributes, data packet size, session duration, session frequency, device identification, and geolocation data. The connection attributes 416 may collectively define how network connections are established, maintained, and secured, and improving the overall performance and security of network 120.

The encryption keys 419 may include the keys themselves, along with metadata such as the date and time they were generated, the algorithm used to generate them, the purpose for which they are intended, encryption or decryption, and/or any associated parameters or settings. For example, a record in the datastore 410 may contain an encryption key for a specific client connection, along with information about when it was created, and which encryption algorithm was used. Additionally, the datastore 410 may store information about the expiration date or lifespan of the encryption keys, as well as any updates or changes made to them over time.

The management service 430, situated within the computing environment 403, may perform one or more functions within the networked environment 400. The management service 430 may oversee the reception and processing of network settings and client connection attributes. Moreover, the management service 430 may aggregate and analyze vast data sets related to the client device 450 and any other node that may be part of the networked environment 400. Furthermore, the management service 430 may be adaptive and scalable, capable of adjusting to fluctuations in user demand and connection complexity. This flexibility may allow the computing environment 403 to support an increased number of nodes within the networked environment 400.

The management service 430 may comprise one or more sub-services such as a communication service 432, a processing service 434, an encryption service 436, a client connection attributes service 438, an abstraction layer service 440, a deflection service 442, and/or a virtual private cloud service 444. each responsible for specific operational aspects.

The communication service 432 may manage data flow within the networked environment 400, orchestrating communication between various network nodes and endpoints. For example, the communication service 432 may utilize advanced routing and encryption algorithms to ensure that all data transmitted across the network remains confidential and integral. According to some aspects, communication service 432 may implement dynamic routing protocols that automatically adjust data paths in response to network congestion or security threats. By adjusting data paths, the communication service 432 may reroute traffic through less congested or more secure pathways, minimizing latency and reducing the risk of interception or eavesdropping.

According to some aspects, the dynamic routing protocols may automatically adjust the routing of data packets through the network 120 based on current conditions and requirements. By continuously analyzing the network’s performance metrics, such as bandwidth usage, latency, and error rates, dynamic routing protocols may make real-time decisions to reroute traffic through less congested or more secure paths. For example, protocols such as Open Shortest Path First (OSPF) or Border Gateway Protocol (BGP) may be employed to dynamically discover the best route for data as network conditions change. OSPF may use a link-state routing algorithm which reacts to changes in network topology by broadcasting updates to all nodes in the network. By employing OSPF, the communication service 432 may ensure all routers have a consistent view of the network so that data can be rerouted through the optimal paths as soon as a change is detected. BGP may be used for routing between autonomous systems on the internet, ensuring data takes the most efficient path across large and complex networks.

Moreover, the dynamic routing protocols of the communication service 432 may contribute significantly to network security. By integrating security policies directly into the routing decisions, the communication service 432 may ensure that data packets are not only routed through the fastest or least congested paths but also the safest. This integration may include dynamically altering routes in response to detected security threats, such as potential data breaches or denial-of-service attacks. For example, if a particular route is compromised, the routing protocol may immediately divert traffic away from that route to protect the data and maintain network integrity, maintaining a robust defense against both external and internal network threats.

The communication service 432 may utilize deflection techniques to add an additional layer of security and complexity to the routing processes. By variably altering communication protocols and routing information, communication service 432 can mislead potential attackers about the actual data paths or make it appear as if the data is heading towards different destinations, preventing targeted attacks and reducing the risk of data interception. Moreover, the Communication Service 432 may leverage real-time assessments of network congestion and perceived security threats to dynamically select data paths. The proactive approach of the communication service 432 may enhance the efficiency of data transmissions and optimize the security measures, ensuring that the network 120 can adapt quickly to changing conditions and maintain the confidentiality and integrity of the data being transmitted.

Furthermore, the communication service 432 may manage a session controller that directs the flow of data packets based on current network load and security protocols. The session controller may route data packets in a manner that obfuscates associated traffic patterns, making it difficult for external analysis to link specific operations or data flows to network nodes or activities. The anonymity and security of the network operations may further obscure endpoint identity and relationships.

The processing service 434 may handle computational and analytical tasks associated with maintaining the efficiency and security of the network 120. For example, the processing service 434 may process large volumes of data and perform complex computations quickly and accurately, supporting real-time decision-making for network management. According to some aspects, the processing service 434 may utilize advanced algorithms to analyze network traffic and identify patterns that may indicate security threats or operational inefficiencies. For example, by processing real-time traffic data, the processing service 434 may detect and respond to potential cyber threats before they cause harm, enhancing the proactive security measures within the network 120.

Moreover, processing service 434 may dynamically scale network resources to adjust computational power and data processing capabilities as needed to meet the demands of the network load. This scalability provided by the processing service 434 may ensure that the network can handle peak loads without degradation of performance, maintaining continuous network availability and performance. In high-demand scenarios, such as during large-scale corporate events or unexpected traffic surges, the processing service 434 may allocate additional resources to maintain optimal operation.

The encryption service 436 may provide robust data protection by dynamically generating and managing encryption keys based on varying network settings. This encryption service 436 may use a cryptographic multi-path algorithm that ensures data packets are encrypted across multiple network paths, thereby complicating potential interception or decryption by unauthorized entities. For example, as data traverses through the network, it may be routed through various pathways, each encrypted with unique keys, which are frequently rotated to enhance security. Additionally, the encryption service 436 may ensure that the keys themselves are stored securely, employing advanced encryption standards and key management practices to prevent unauthorized access. Moreover, the encryption service 436 may integrate with other network components to apply encryption dynamically based on real-time assessments of network security needs, thereby maintaining optimal data confidentiality and integrity even in high-threat environments.

The client connection attributes service 438 may manage and dynamically adjust network settings to respond to varying network conditions and security threats. The client connection attributes service 438 may configure client connection attributes such as IP addresses, port numbers, and protocol types, and adjusts these settings in real-time based on ongoing analysis of network traffic and external threat levels. By employing a non-linear updating schedule, the client connection attributes service 438 may enhance unpredictability in the security measures, making it difficult for attackers to anticipate changes or detect patterns. For example, the client connection attributes service 438 may suddenly change the IP address or encrypt certain traffic, thereby obfuscating the data flow. Additionally, the client connection attributes service 438 may use data from various geographical locations to optimize network settings locally, ensuring efficient and secure data handling tailored to specific regional requirements.

The Abstraction Layer Service 440 may obscure the network's operational details from unauthorized users by manipulating the visibility and characteristics of network traffic. This Abstraction Layer Service 440 may adjust the traffic flow to appear as generic as possible, blending it with common internet traffic to prevent identification and tracking of specific data packets or network nodes. By continuously altering connection attributes such as the timing of transmissions and the size of data packets, the Abstraction Layer Service 440 may create a moving target for potential attackers. For instance, the Abstraction Layer Service 440 may randomize packet sizes or delay certain transmissions to confuse pattern analysis algorithms. Moreover, the Abstraction Layer Service 440 may use advanced algorithms to predict and respond to potential security threats, proactively adjusting network configurations to maintain security without compromising network performance.

The deflection service 442 may enhance network security by introducing variability and randomness into the routing and protocol handling within the network 120. The Abstraction Layer Service 440 may mislead and confuse potential eavesdroppers by constantly altering the communication pathways and protocols used for data transmission. For example, the Abstraction Layer Service 440 may choose to route sensitive data through less predictable paths or switch communication protocols sporadically to avoid pattern recognition. Additionally, the Abstraction Layer Service 440 may assess real-time network conditions and security threats to optimize the paths chosen for data transmission, ensuring that the data travels through the most secure and least congested routes. Thereby the Abstraction Layer Service 440 may protect data from interception and maintain high network efficiency and resilience against attacks.

The virtual private cloud service 444 may provide a secure and isolated environment for network operations, ensuring that all data within the virtual private cloud (VPC) is shielded from public access. By leveraging cloud technologies, this virtual private cloud service 444 may offer scalable and flexible network resources that dynamically adjust to the changing demands of the network, such as varying loads or security requirements. Data within the VPC is encrypted using multiple layers of encryption, which are managed by the encryption service 436, adding an extra layer of security. Additionally, the virtual private cloud service 444 may ensure that all data transmission to and from the VPC goes through secured gateways, which may use advanced encryption and monitoring techniques to prevent unauthorized access. For example, data packets entering or leaving the VPC may be routed through multiple, randomized paths to obscure their origin or destination, further enhancing data security.

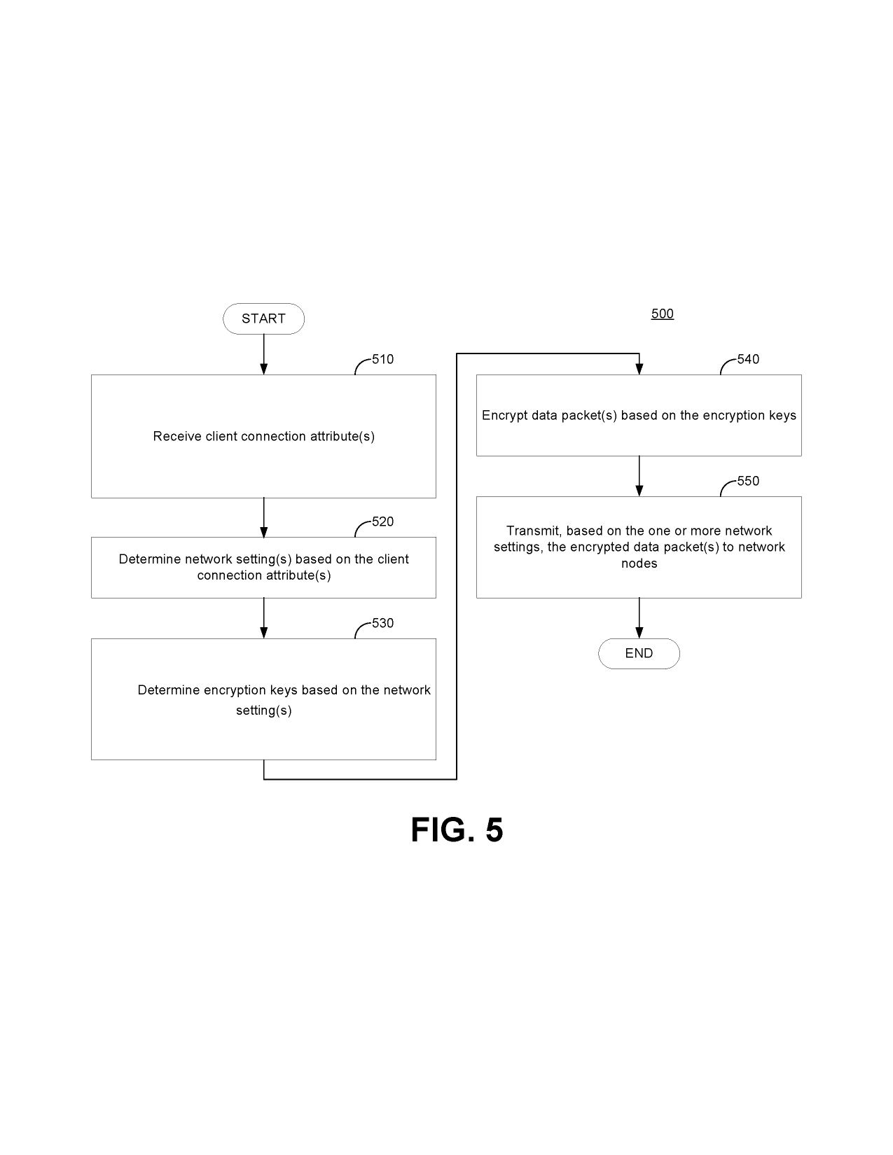

Referring now to FIG. 5, illustrated is a flowchart of a process 500, according to one example of the disclosed systems and processes. The process 500 may demonstrate a technique for obscuring the identity and relationships of endpoints in a network to prevent unauthorized analysis and tracking of network traffic. In some embodiment, the system comprises one or more computing devices, each equipped with processors configured to perform the following steps:

At box 510, the process 500 may include receiving client connection attributes (e.g., determined by the abstraction layer 123). The client connection attributes may be based on network traffic and common connection attributes stored in a database 303. Moreover, client connection attributes may include specific settings or parameters associated with individual network connections, such as IP addresses, port numbers, protocol types, session durations, and packet sizes. The attributes may be determined by the abstraction layer 123.

The abstraction layer 123 may analyze and modify network traffic to make it indistinguishable from typical internet communications. The abstraction layer 123 may dynamically adjust the client connection attributes to prevent unauthorized tracking or analysis of the data flows. For example, the abstraction layer 123 may alter the IP address or switch the communication protocols used by a client device intermittently. For example, the abstraction layer 123 may change a device's apparent geographical location or the encryption standards it uses, depending on the sensitivity of the data being transmitted and perceived external threats.

The network traffic may comprise the flow of data across the network 120, including the data packets being sent and received by the client devices connected to the network 120. The abstraction layer 123 may analyze the traffic to identify patterns or potential security risks and to make real-time adjustments to the client connection attributes. For example, if an unusually high volume of traffic is detected from a particular IP address, the abstraction layer 123 may temporarily change the routing rules for that address to monitor or mitigate potential threats.

Common connection attributes may include standardized or frequently used settings. The common connection attributes may be stored in a database, such as database 303. The common connection attributes may provide a baseline from which the abstraction layer can start when adjusting the client connection attributes. Moreover, the common connection attributes may include common IP ranges, standard port numbers, and typical protocol settings that are widely used and generally represent uninteresting traffic (e.g., non-suspicious traffic). By starting with these common attributes, the abstraction layer may more effectively blend the network traffic into the general flow of internet traffic, making it harder for bad actors to pinpoint any unusual or suspicious activity.

At box 520, the process 500 may include determining network settings. The process 500 may determine appropriate network settings based on the received client connection attributes. Determining network settings may include selecting domain names or paths that are common in internet traffic to blend network traffic and achieve security requirements. Single or multi-cloud topologies may be utilized to merge network traffic into large volumes of generic traffic, ensuring that network attributes are similar and uninteresting to make them indistinguishable from regular network traffic. Additionally, a common cloud storage feature such as those in AWS or Azure may be used to stage connection details, and node anonymity may be employed to prevent cybercriminals from recognizing specific nodes as targets. Node association may be anonymized to prevent the identification of multiple client nodes as connecting to the same destination, thereby maintaining the secrecy of operational relationships.

At box 530, the process 500 may include generating encryption keys using encryption service 306. A plurality of encryption keys may be determined based on the network settings. The process of generating encryption keys may comprise receiving one or more client connection attributes, which may be determined by an abstraction layer of a network based on network traffic associated with the network and one or more common connection attributes stored in a database. Based on the client connection attributes, the encryption mechanism may determine one or more network settings and generate a plurality of encryption keys based on the one or more network settings. The encryption keys may be used to encrypt one or more data packets. The encrypted data packets may be transmitted to a plurality of network nodes based on the network settings. The encryption keys may be generated using a cryptographic multi-path algorithm that leverages multiple paths through the network, ensuring robust security and making it difficult for unauthorized entities to decrypt the data packets.

At box 540, the process 500 may include encrypting data packets. The process 500 may encrypt data packets using the determined encryption keys. Encrypting data packets may include using the one or more client connection attributes, which may be determined by abstraction layer 123 of network 120 based on network traffic associated with the network 120 and one or more common connection attributes (e.g., stored in a database).

At box 550, the process 500 may include transmitting encrypted data packets. The encrypted data packets may be transmitted to multiple network nodes based on the network settings. Transmitting the encrypted data packets may include encrypting the data packets using a plurality of encryption keys generated based on the network settings and client connection attributes. Once encrypted, the data packets may be transmitted to multiple network nodes based on the network settings. The network settings may include a randomized routing path, ensuring that the data packets are transmitted through various paths in the network, making it difficult for unauthorized entities to track or intercept the data. By transmitting the encrypted data packets to multiple network nodes, the process 500 enhances security and confidentiality, as the data remains protected even if one of the nodes is compromised.

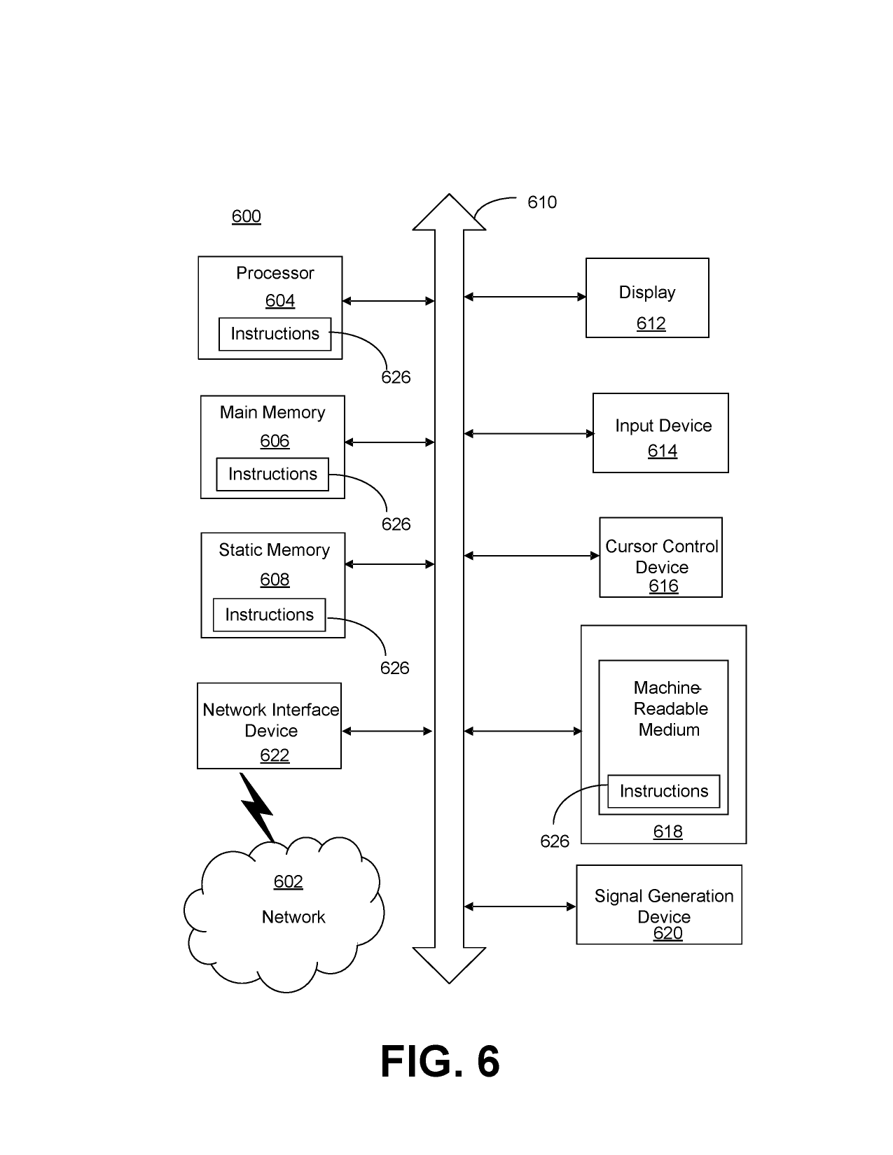

FIG. 6 depicts an exemplary diagrammatic representation of a machine in the form of a computer system 600 within which a set of instructions, when executed, may cause the machine to perform any one or more of the methods described above. One or more instances of the machine can operate, for example, as computing device 700, processor 702, server 204, database 206, and other devices of FIGS. 1-5 and 7. In some examples, the machine may be connected (e.g., using a network 602) to other machines. In a networked deployment, the machine may operate in the capacity of a server or a client user machine in a server-client user network environment, or as a peer machine in a peer-to-peer (or distributed) network environment.

The machine may comprise a server computer, a client user computer, a personal computer (PC), a tablet, a smart phone, a laptop computer, a desktop computer, a control system, a network router, switch or bridge, or any machine capable of executing a set of instructions (sequential or otherwise) that specify actions to be taken by that machine. It will be understood that a communication device of the subject disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methods discussed herein.

Computer system 600 may include a processor (or controller) 604 (e.g., a central processing unit (CPU)), a graphics processing unit (GPU, or both), a main memory 606 and a static memory 608, which communicate with each other via a bus 610. The computer system 600 may further include a display unit 612 (e.g., a liquid crystal display (LCD), a flat panel, or a solid-state display). Computer system 600 may include an input device 614 (e.g., a keyboard), a cursor control device 616 (e.g., a mouse), a disk drive unit 618, a signal generation device 620 (e.g., a speaker or remote control) and a network interface device 622. In distributed environments, the examples described in the subject disclosure can be adapted to utilize multiple display units 612 controlled by two or more computer systems 600. In this configuration, presentations described by the subject disclosure may in part be shown in a first of display units 612, while the remaining portion is presented in a second of display units 612.

The disk drive unit 618 may include a tangible computer-readable storage medium on which is stored one or more sets of instructions (e.g., instructions 626) embodying any one or more of the methods or functions described herein, including those methods illustrated above. Instructions 626 may also reside, completely or at least partially, within main memory 606, static memory 608, or within processor 604 during execution thereof by the computer system 600. Main memory 606 and processor 604 also may constitute tangible computer-readable storage media.

While examples of a system for network security have been described in connection with various computing devices/processors, the underlying concepts may be applied to any computing device, processor, or system capable of preventing unauthorized analysis and tracking of network traffic. The various techniques described herein may be implemented in connection with hardware or software or, where appropriate, with a combination of both. Thus, the methods and devices may take the form of program code (i.e., instructions) embodied in concrete, tangible, storage media having a concrete, tangible, physical structure. Examples of tangible storage media include floppy diskettes, CD-ROMs, DVDs, hard drives, or any other tangible machine-readable storage medium (computer-readable storage medium). Thus, a computer-readable storage medium is not a signal. A computer-readable storage medium is not a transient signal. Further, a computer readable storage medium is not a propagating signal. A computer-readable storage medium as described herein is an article of manufacture. When the program code is loaded into and executed by a machine, such as a computer, the machine becomes a device for network security. In the case of program code execution on programmable computers, the computing device will generally include a processor, a storage medium readable by the processor (including volatile or nonvolatile memory or storage elements), at least one input device, and at least one output device. The program(s) can be implemented in assembly or machine language, if desired. The language can be a compiled or interpreted language and may be combined with hardware implementations.

The methods and devices associated with network security as described herein also may be practiced via communications embodied in the form of program code that is transmitted over some transmission medium, such as over electrical wiring or cabling, through fiber optics, or via any other form of transmission, wherein, when the program code is received and loaded into and executed by a machine, such as an erasable programmable read-only memory (EPROM), a gate array, a programmable logic device (PLD), a client computer, or the like, the machine becomes a device for implementing network security as described herein. When implemented on a general-purpose processor, the program code combines with the processor to provide a unique device that operates to invoke the functionality of obscuring the identity and relationships of endpoints in a network.

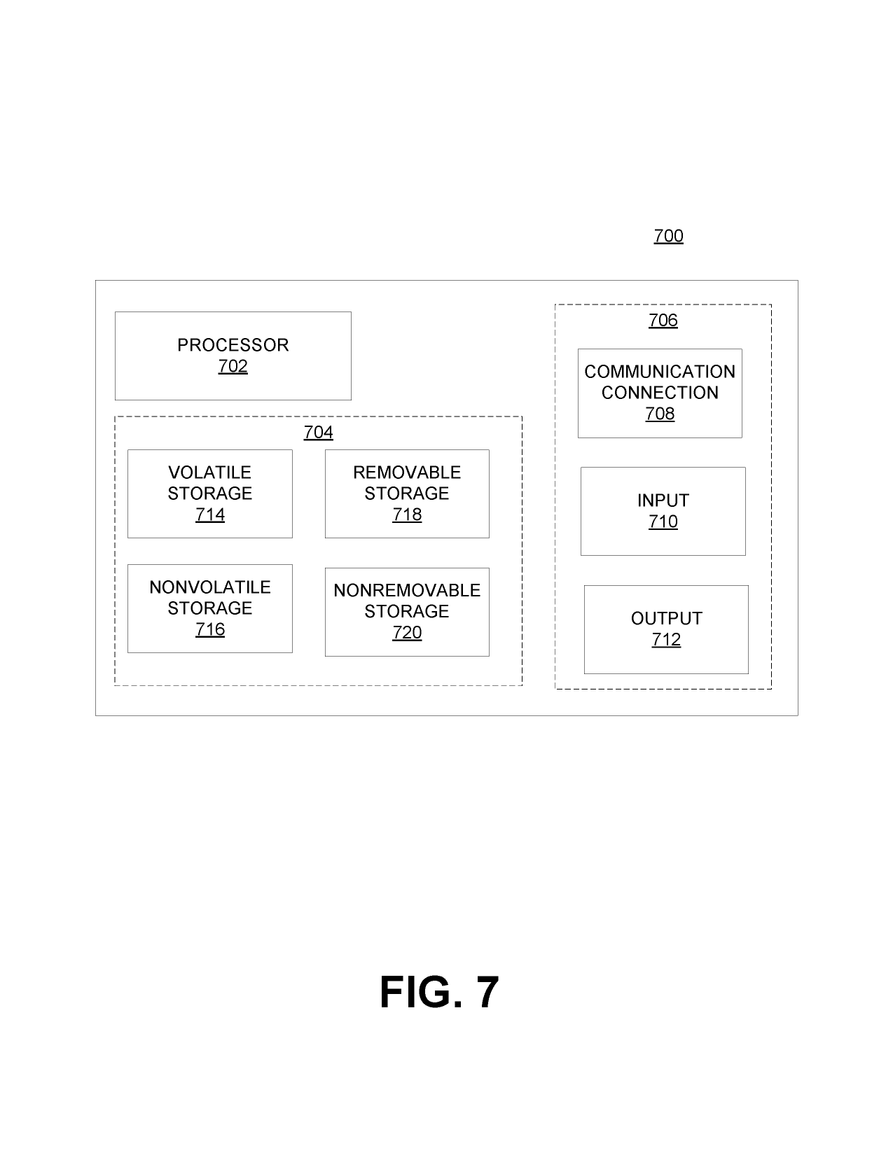

FIG. 7 is a block diagram of a computing device 700 that may be connected to or comprise a component of environment 100, environment 200, environment 300, and/or networked environment 400. Computing device 700 may comprise hardware or a combination of hardware and software. The functionality to obscure the identity and relationships of endpoints in a network may reside in one or a combination of computing devices 700. Computing device 700 depicted in FIG. 7 may represent or perform functionality of an appropriate computing device 700, or a combination of computing devices 700, such as, for example, a component or various components of a network security system, a computing device, a processor, a server, a gateway, a database, a firewall, a router, a switch, a modem, an encryption tool, a virtual private network (VPN), a network access control (NAC) device, a secure web gateway, or the like, or any appropriate combination thereof. It is emphasized that the block diagram depicted in FIG. 7 is exemplary and not intended to imply a limitation to a specific example or configuration. Thus, computing device 700 may be implemented in a single device or multiple devices (e.g., single server or multiple servers, single gateway or multiple gateways, single controller or multiple controllers). Multiple network entities may be distributed or centrally located. Multiple network entities may communicate wirelessly, via hard wire, or any appropriate combination thereof.

Computing device 700 may comprise a processor 702 and a memory 704 coupled to processor 702. Memory 704 may contain executable instructions that, when executed by processor 702, cause processor 702 to effectuate operations associated with network security. As evident from the description herein, computing device 700 is not to be construed as software per se.

In addition to processor 702 and memory 704, computing device 700 may include an input/output system 706. Processor 702, memory 704, and input/output system 706 may be coupled together (coupling not shown in FIG. 7) to allow communications between them. Each portion of computing device 700 may comprise circuitry for performing functions associated with each respective portion. Thus, each portion may comprise hardware, or a combination of hardware and software. Accordingly, each portion of computing device 700 is not to be construed as software per se. Input/output system 706 may be capable of receiving or providing information from or to a communications device or other network entities configured for network security. For example, input/output system 706 may include a wireless communication (e.g., 3G/4G/5G/GPS) card. Input/output system 706 may be capable of receiving or sending video information, audio information, control information, image information, data, or any combination thereof. Input/output system 706 may be capable of transferring information with computing device 700. In various configurations, input/output system 706 may receive or provide information via any appropriate means, such as, for example, optical means (e.g., infrared), electromagnetic means (e.g., RF, Wi-Fi, Bluetooth®, ZigBee®), acoustic means (e.g., speaker, microphone, ultrasonic receiver, ultrasonic transmitter), or a combination thereof. In an example configuration, input/output system 706 may comprise a Wi-Fi finder, a two-way GPS chipset or equivalent, or the like, or a combination thereof.

Input/output system 706 of computing device 700 also may contain a communication connection 708 that allows computing device 700 to communicate with other devices, network entities, or the like. Communication connection 708 may comprise communication media. Communication media typically embody computer-readable instructions, data structures, program modules or other data in a modulated data signal such as a carrier wave or other transport mechanism and includes any information delivery media. By way of example, and not limitation, communication media may include wired media such as a wired network or direct-wired connection, or wireless media such as acoustic, RF, infrared, or other wireless media. The term computer-readable media as used herein includes both storage media and communication media. Input/output system 706 also may include an input device 710 such as keyboard, mouse, pen, voice input device, or touch input device. Input/output system 706 may also include an output device 712, such as a display, speakers, or a printer.

Processor 702 may be capable of performing functions associated with network security, such as functions for obscuring the identity and relationships of endpoints in a network, as described herein. For example, processor 702 may be capable of, in conjunction with any other portion of computing device 700, preventing unauthorized analysis and tracking of network traffic, as described herein.

Memory 704 of computing device 700 may comprise a storage medium having a concrete, tangible, physical structure. As is known, a signal does not have a concrete, tangible, physical structure. Memory 704, as well as any computer-readable storage medium described herein, is not to be construed as a signal. Memory 704, as well as any computer-readable storage medium described herein, is not to be construed as a transient signal. Memory 704, as well as any computer-readable storage medium described herein, is not to be construed as a propagating signal. Memory 704, as well as any computer-readable storage medium described herein, is to be construed as an article of manufacture.

Memory 704 may store any information utilized in conjunction with network security. Depending upon the exact configuration or type of processor, memory 704 may include a volatile storage 714 (such as some types of RAM), a nonvolatile storage 716 (such as ROM, flash memory), or a combination thereof. Memory 704 may include additional storage (e.g., a removable storage 718 or a non-removable storage 720) including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by computing device 700. Memory 704 may comprise executable instructions that, when executed by processor 702, cause processor 702 to effectuate operations associated with network security.

While the disclosed systems have been described in connection with the various examples of the various figures, it is to be understood that other similar implementations may be used, or modifications and additions may be made to the described examples of a network security system without deviating therefrom. For example, one skilled in the art will recognize that a network security system as described in the instant application may apply to any environment, whether wired or wireless, and may be applied to any number of such devices connected via a communications network and interacting across the network. Therefore, the disclosed systems as described herein should not be limited to any single example, but rather should be construed in breadth and scope in accordance with the appended claims.

In describing preferred methods, systems, or apparatuses of the subject matter of the present disclosure – obscuring the identity and relationships of endpoints in a network – as illustrated in the Figures, specific terminology is employed for the sake of clarity. The claimed subject matter, however, is not intended to be limited to the specific terminology so selected. In addition, the use of the word “or” is generally used inclusively unless otherwise provided herein.

This written description uses examples to enable any person skilled in the art to practice the claimed subject matter, including making and using any devices or systems and performing any incorporated methods. Other variations of the examples are contemplated herein.

What is claimed:

1. One or more computing devices, comprising one or more processors, configured to:
receive one or more client connection attributes, wherein the one or more client connection attributes are determined by an abstraction layer of a network based on network traffic associated with the network and one or more common connection attributes stored in a database;
determine, based on the one or more client connection attributes, one or more network settings;
determine, based on the one or more network settings, a plurality of encryption keys;
encrypt, based on the plurality of encryption keys, one or more data packets; and
transmit, to a plurality of network nodes based on the one or more network settings, the one or more encrypted data packets.

2. The one or more computing devices of claim 1, wherein the one or more client connection attributes are updated based on a non-linear schedule.

3. The one or more computing devices of claim 1, wherein the one or more network settings comprise a plurality of dynamically selected network ports or encryption protocols.

4. The one or more computing devices of claim 1, wherein the plurality of encryption keys is generated by a cryptographic multi-path algorithm that leverages multiple paths through the network.

5. The one or more computing devices of claim 1, wherein the encryption of the data packets is associated with a plurality of encryption layers.

6. The one or more computing devices of claim 1, wherein the one or more encrypted data packets are transmitted to the plurality of network nodes based on a randomized routing path.

7. The one or more computing devices of claim 1, wherein the one or more processors are further configured to periodically receive one or more updated client connection attributes from a generic storage account.

8. The one or more computing devices of claim 1, wherein the database storing the common connection attributes is part of a virtual private cloud.

9. The one or more computing devices of claim 1, wherein determining the one or more client connection attributes includes consideration of a geographical location of a client device.

10. The one or more computing devices of claim 1, wherein the abstraction layer adjusts the client connection attributes in real-time based on analysis of conditions associated with the network traffic.

11. The one or more computing devices of claim 1, wherein determining the one or more network settings comprises selecting domain names or paths that are common in internet traffic.

12. The one or more computing devices of claim 1, wherein the network traffic is managed by a dedicated session controller.

13. The one or more computing devices of claim 1, wherein the one or more client connection attributes comprise network configuration data.

14. The one or more computing devices of claim 1, wherein communication with the abstraction layer is facilitated by an application programming interface (API) over secure channels.

15. The computing device of claim 1, wherein the one or more client connection attributes and a network capacity are dynamically scaled to respond to fluctuations in network demand and threat levels.

16. The one or more computing devices of claim 1, herein the one or more encrypted data packets are transmitted through a gateway in a virtual private cloud.

17. The one or more computing devices of claim 1, wherein determining the one or more client connection attributes is based on a deflection technique.

18. The one or more computing devices of claim 17, wherein the deflection technique comprises dynamically selecting data paths based on real-time assessments of network congestion and perceived security threats.

19. A method performed by one or more computing devices, comprising one or more processors, the method comprising:
receiving one or more client connection attributes, wherein the one or more client connection attributes are determined by an abstraction layer of a network based on network traffic associated with the network and one or more common connection attributes stored in a database;
determining, based on the one or more client connection attributes, one or more network settings;
determining, based on the one or more network settings, a plurality of encryption keys;
encrypting, based on the plurality of encryption keys, one or more data packets; and
transmitting, to a plurality of network nodes based on the one or more network settings, the one or more encrypted data packets to a plurality of network nodes.

20. A system comprising:
one or more processors; and
memory coupled with the one or more processors, the memory storing executable instructions that when executed by the one or more processors cause the one or more processors to effectuate operations comprising:
receiving one or more client connection attributes, wherein the one or more client connection attributes are determined by an abstraction layer of a network based on network traffic associated with the network and one or more common connection attributes stored in a database;
determining, based on the one or more client connection attributes, one or more network settings;
determining, based on the one or more network settings, a plurality of encryption keys;
encrypting, based on the plurality of encryption keys, one or more data packets; and
transmitting, to a plurality of network nodes based on the one or more network settings, the one or more encrypted data packets to a plurality of network nodes.
